(19) United States
(12) Patent Application Publication
(10) Pub. No.: US 2022/0383145 A1
(43) Pub. Date: Dec. 1, 2022

(54) Regression and Time Series Forecasting

(71) Applicant: Google LLC, Mountain View, CA (US)

(72) Inventors: Rajat Sen, Mountain View, CA (US); Shuxin Nie, Mountain View, CA (US); Yaguang Li, Mountain View, CA (US); Abhimanyu Das, Mountain View, CA (US); Nicolas Loeff, Mountain View, CA (US); Ananda Theertha Suresh, Mountain View, CA (US); Pranjal Awasthi, Mountain View, CA (US); Biswajit Paria, Mountain View, CA (US)

(73) Assignee: Google LLC, Mountain View, CA (US)

(21) Appl. No.: 17/804,082

(22) Filed: May 25, 2022

Related U.S. Application Data
(60) Provisional application No. 63/194,533, filed on May 28, 2021.

(51) Int. Cl. G06N 5/02

(52) U.S. Cl. CPC G06N 5/022

(57) ABSTRACT

A method for regression and time series forecasting includes obtaining a set of hierarchical time series, each time series in the set of hierarchical time series including a plurality of time series data values. The method includes determining, using the set of hierarchical time series, a basis regularization of the set of hierarchical time series and an embedding regularization of the set of hierarchical time series. The method also includes training a model using the set of hierarchical time series and a loss function based on the basis regularization and the embedding regularization. The method includes forecasting, using the trained model and one of the time series in the set of hierarchical time series, an expected time series data value in the one of the time series.

### CROSS REFERENCE TO RELATED APPLICATIONS

This U.S. patent application is a continuation and claims priority under 35 U.S.C. § 119(e) to U.S. Provisional Application 63/194,533, filed on May 28, 2021. The disclosure of the prior application is considered part of the disclosure of this application and is hereby incorporated by reference in its entirety.

### TECHNICAL FIELD

This disclosure relates to regression and time series forecasting.

### BACKGROUND

Hierarchical forecasting is a key problem in many practical multivariate forecasting applications as the goal is to simultaneously predict a large number of correlated time series that are arranged in a pre-specified aggregation hierarchy while exploiting hierarchical correlations. Machine learning models can be used to predict time series at different levels of the hierarchy.

### SUMMARY

One aspect of the disclosure provides a computer-implemented method for forecasting a time series using a model. The computer-implemented method when executed by data processing hardware causes the data processing hardware to perform operations including obtaining a set of hierarchical time series, each time series in the set of hierarchical time series including a plurality of time series data values. The operations further include determining, using the set of hierarchical time series, a basis regularization of the set of hierarchical time series. The operations include determining, using the set of hierarchical time series, an embedding regularization of the set of hierarchical time series. The operations further include training a model using the set of hierarchical time series and a loss function based on the basis regularization and the embedding regularization. The operations include forecasting, using the trained model and one of the time series in the set of hierarchical time series, an expected time series data value in the one of the time series.

Implementations of the disclosure may include one or more of the following optional features. In some implementations, the loss function includes minimizing a sum of a mean absolute error, the basis regularization, and the embedding regularization. In other implementations, training the model includes using mini-batch stochastic gradient descent. Further, the operations may include, prior to training the model, for each respective time series data value, downscaling the respective time series data value based on a level of hierarchy associated with the respective time series data value.

The set of hierarchical time series may include a pre-defined hierarchy of a plurality of nodes, each node associated with one of the time series data values. In some implementations, the basis regularization is based on a set of basis vectors associated with the set of hierarchical time series. In other implementations, the embedding regularization is based on a set of weight vectors associated with the set of hierarchical time series.

In some implementations, the basis regularization represents a data-dependent global basis of the set of hierarchical time series and the embedding regularization provides a coherence constraint on the trained model. In other implementations, the model includes a differentiable learning model. In these implementations, the differentiable learning model may include a recurrent neural network, a temporal convolutional network, or a long short term memory network.

Another aspect of the disclosure provides a system for forecasting a time series using a model. The system includes data processing hardware and memory hardware in communication with the data processing hardware. The memory hardware stores instructions that when executed on the data processing hardware cause the data processing hardware to perform operations. The operations include obtaining a set of hierarchical time series, each time series in the set of hierarchical time series including a plurality of time series data values. The operations further include determining, using the set of hierarchical time series, a basis regularization of the set of hierarchical time series. The operations include determining, using the set of hierarchical time series, an embedding regularization of the set of hierarchical time series. The operations further include training a model using the set of hierarchical time series and a loss function based on the basis regularization and the embedding regularization. The operations include forecasting, using the trained model and one of the time series in the set of hierarchical time series, an expected time series data value in the one of the time series.

This aspect may include one or more of the following optional features. In some implementations, the loss function includes minimizing a sum of a mean absolute error, the basis regularization, and the embedding regularization. In other implementations, training the model includes using mini-batch stochastic gradient descent. Further, in some implementations, the operations include, prior to training the model, for each respective time series data value, downscaling the respective time series data value based on a level of hierarchy associated with the respective time series data value.

The set of hierarchical time series may include a pre-defined hierarchy of a plurality of nodes, each node associated with one of the time series data values. In some implementations, the basis regularization is based on a set of basis vectors associated with the set of hierarchical time series. In other implementations, the embedding regularization is based on a set of weight vectors associated with the set of hierarchical time series.

In some implementations, the basis regularization represents a data-dependent global basis of the set of hierarchical time series and the embedding regularization provides a coherence constraint on the trained model. In other implementations, the model includes a differentiable learning model. In these implementations, the differentiable learning model may include a recurrent neural network, a temporal convolutional network, or a long short term memory network

The details of one or more implementations of the disclosure are set forth in the accompanying drawings and the description below. Other aspects, features, and advantages will be apparent from the description and drawings, and from the claims

### DESCRIPTION OF DRAWINGS

FIG. 1 is a schematic view of a system for regression and time series forecasting.

FIG. 2 is a schematic view of an example hierarchical time series.

FIG. 3 is a schematic view of an example model architecture for forecasting time series.

FIG. 4 is a schematic view of an example training process for a model to forecast time series.

FIG. 5 is a flow chart of an exemplary arrangement of operations for a method for forecasting a time series using a model.

FIG. 6 is a flow chart of an exemplary arrangement of operations for a method of training a model for forecasting a time series.

FIG. 7 is a schematic view of an example computing device that may be used to implement the systems and methods described herein.

Like reference symbols in the various drawings indicate like elements.

### DETAILED DESCRIPTION

A multivariate time series is a series of time-dependent variables where each variable depends not only on its past values, but also has some dependency on other variables. Often, the time series is arranged in a natural multi-level hierarchy, such as a tree with leaf nodes corresponding to time series at the finest granularity, and the edges representing parent-child relationships. Multivariate forecasting generally involves using machine learning models to predict values of future time series, and can be used in various domains such as retail demand forecasting, financial predictions, power grid optimization, road traffic modeling, online ads, etc. In many of these domains, predicting time series involves simultaneously forecasting a large number of potentially correlated time series for various downstream applications. For example, in a retail domain, the time series might capture sales of items in a product inventory, and items can be grouped into subcategories and categories such that they are arranged in a product taxonomy. Multivariate forecasting for the retail domain would involve predicting sales of product inventory in one or more categories and/or subcategories.

Typical approaches for hierarchical forecasting suffer from various short comings. For example, a bottom-up approach trains one or more models to obtain predictions at the leaf nodes and then aggregates up along the hierarchy tree to obtain predictions at higher level nodes. Another approach, known as the reconciliation method, trains one or more models to obtain predictions at all nodes in the tree and then “reconciles” or modifies the predictions in a post-processing step to obtain coherent predictions. Each of these approaches has deficiencies which result in unsatisfactory results. For example, the bottom-up approach aggregates noise as the model moves up to higher levels of the tree while the reconciliation method does not jointly optimize the forecasting predictions along with the constraints for reconciling predictions. Further, other methods such as Deep Neural Network (DNN) models can be difficult to scale and may not be adapted for granular predictions (i.e., allow for prediction of a single time-series without requiring historical data for all the time series in the hierarchy).

Implementations herein are directed toward a regression and time series forecaster that includes a model trainer that trains one or more machine learning models configured for regression and time series forecasting. In some implementations, the model trainer trains a model for forecasting hierarchical time series data that is scalable at inference time while preserving coherence among the time series forecasts. The model trainer may train an end-to-end model for regression predictions and/or time series forecasts that implements Maximum Likelihood Estimation (MLE) and flexibly captures various inductive biases without having to select a specific loss metric at training time. Further, the one or more models may be trained using a single-stage pipeline on all the time series data, without any separate post-processing. The one or more models may also be efficiently trainable on large dataset, without requiring batch sizes that scale with the number of time series.

The regression and time series forecaster may address the requirements for hierarchical forecasting using two components, both of which can support coherence constraints. The first component is a function of the historical values of a time series, without distinguishing between the individual time series themselves in any other way. Coherence constraints on such a model correspond to imposing an additivity property on the prediction function, which constrains the model to be a linear autoregressive (AR) model. However, implementations herein implement time-varying autoregressive coefficients that can themselves be nonlinear functions of the timestamp and other global features. This component will be herein referred to as the time-varying autoregressive model.

The second component, herein referred to as a basis decomposition model, is aimed at modeling the global temporal patterns in the dataset through identifying a small set of temporal global basis functions. The basis time-series may express the individual dynamics of each time series. In some implementations, the basis time-series are encoded in a trained sequence to sequence model in a functional form. Then, each time series may be associated with a learned embedding vector that specifies the weights for decomposition along these basis functions. Predicting a time series into the future using this model can be performed by extrapolating the global basis functions and combining them using one or more weight vectors, without explicitly using the past values of that time series. The coherence constraints therefore only impose constraints on the embedding vector of each time series, which can be modeled by a hierarchical regularization function.

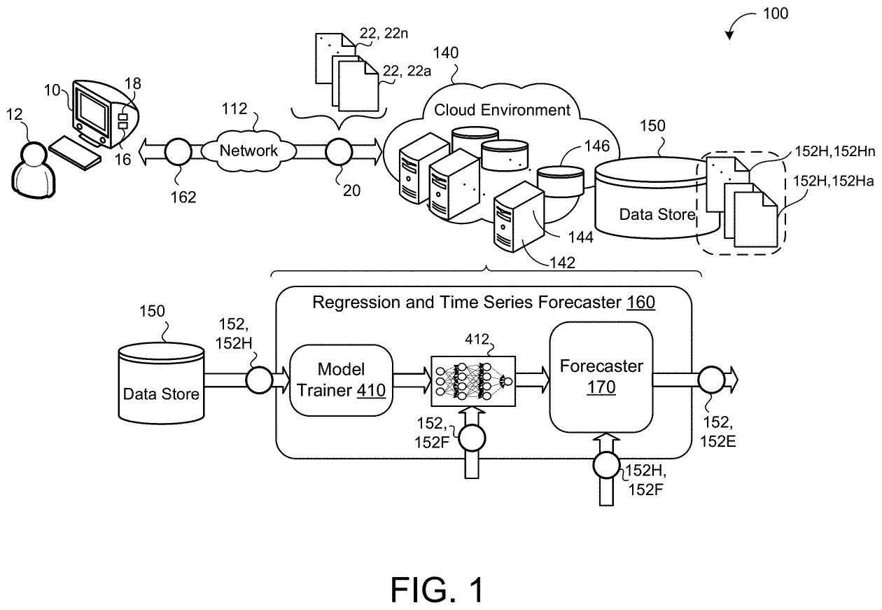

Referring now to FIG. 1, in some implementations, an example regression and time series forecasting system 100 includes a remote system 140 in communication with one or more user devices 10 via a network 112. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). A data store 150 (i.e., a remote storage device) may be overlain on the storage resources 146 to allow scalable use of the storage resources 146 by one or more of the clients (e.g., the user device 10) or the computing resources 144. The data store 150 is configured to store a plurality of time series data values 152, 152a-n (also referred to herein as just “data values”) within, for example, one or more tables 158, 158a-n (i.e., a cloud database). The data store 150 may store any number of tables 158 at any point in time.

The remote system 140 is configured to receive a query 20 from a user device 10 associated with a respective user 12 via, for example, the network 112. The user device 10 may correspond to any computing device, such as a desktop workstation, a laptop workstation, or a mobile device (i.e., a smart phone). The user device 10 includes computing resources 18 (e.g., data processing hardware) and/or storage resources 16 (e.g., memory hardware). Each query 20 requests the remote system 140 to predict or forecast one or more values (e.g., time series) in one or more requests 22, 22a-n.

The remote system 140 executes a regression and time series forecaster 160 for predicting or forecasting expected time series data values 152, 152E in historical data values 152, 152H (e.g., univariate time series data values 152) and/or future data values, 152, 152F. The regression and time series forecaster 160 is configured to receive the query 20 from the user 12 via the user device 10. Each query 20 may include multiple requests 22. Each request 22 requests the regression and time series forecaster 160 to predict or forecast one or more expected data values 152E in the same or a different set of data values 152. For example, the query 20 includes a request for the regression and time series forecaster 160 to determine one or more expected data values 152E in multiple different sets of time series data values 152 simultaneously.

The regression and time series forecaster 160 includes a model trainer 410. The model trainer 410 generates and trains one or more models 412 (e.g., neural networks) for each request 22. The model trainer 410 may train the model(s) 412 on historical data values 152H (i.e., data values 152) retrieved from one or more tables 158 stored on the data store 150 that are associated with the requests 22. Alternatively, the query 20 includes the historical data values 152H. In this case, the user 12 (via the user device 10) may provide the historical data values 152H when the historical data values 152H is not otherwise available via the data storage 150. The request 22 may direct the regression and time series forecaster 160 to retrieve the historical data values 152H from any other remote source. In some examples, the historical data values 152H are stored in databases with multiple columns and multiple rows. For example, one column includes the time series data while another column includes timestamp data that correlates specific points in time with the time series data.

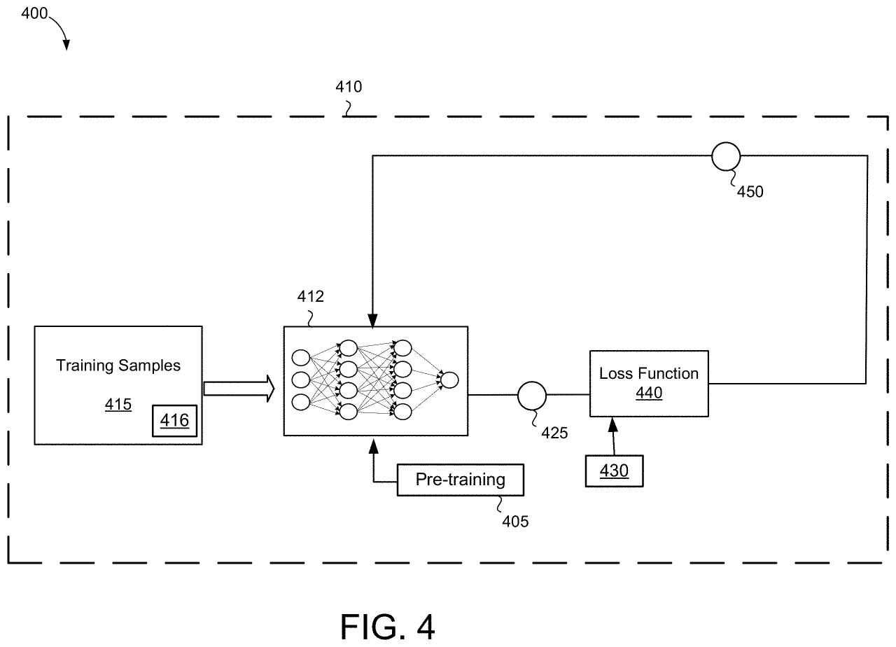

The model trainer 410 may generate and/or train multiple models 412 of different types or with different parameters consecutively or simultaneously (i.e., in parallel). For examples, the model trainer 410 trains a differentiable learning model, a deep neural network, a recurrent neural network, a temporal convolutional network, a long short term memory network, etc. The regression and time series forecaster 160 may include a forecaster 170. The forecaster 170, using the one or more trained models 412, forecasts or predicts the expected time series data value 152, 152E. The forecaster 170 may forecast expected data values 152E for each of the historical data values 152H. That is, after the model 412 is trained, the regression and time series forecaster 160 may provide each historical data value 152H to the trained model 412, and based on the model's prediction, the forecaster 170 determines an expected time series data value 152E for the respective historical data value 152H. The forecaster 170 may also forecast expected data values 152E for future data values 152F. The historical data values 152H represent data values 152 that the model 412 trains on while future data values 152F represent data values 152 that the model 412 does not train on. For example, the time series forecaster 160 receives the future data values 152F after training the model 412 is complete. The process of training one or more models is discussed in greater detail with respect to FIG. 4.

The system of FIG. 1 is presented for illustrative purposes only and is not intended to be limiting. For example, although only a single example of each component is illustrated, the system 100 may include any number of components 10, 112, 140, 150, and 160. Further, although some components are described as being located in a cloud computing environment 140, in some implementations, some or all of the components may be hosted locally on the user device 10. Further, in various implementations, some or all of the components 150 and 160, are hosted locally on user device 110, remotely (such as in the cloud computing environment 140), or some combination thereof.

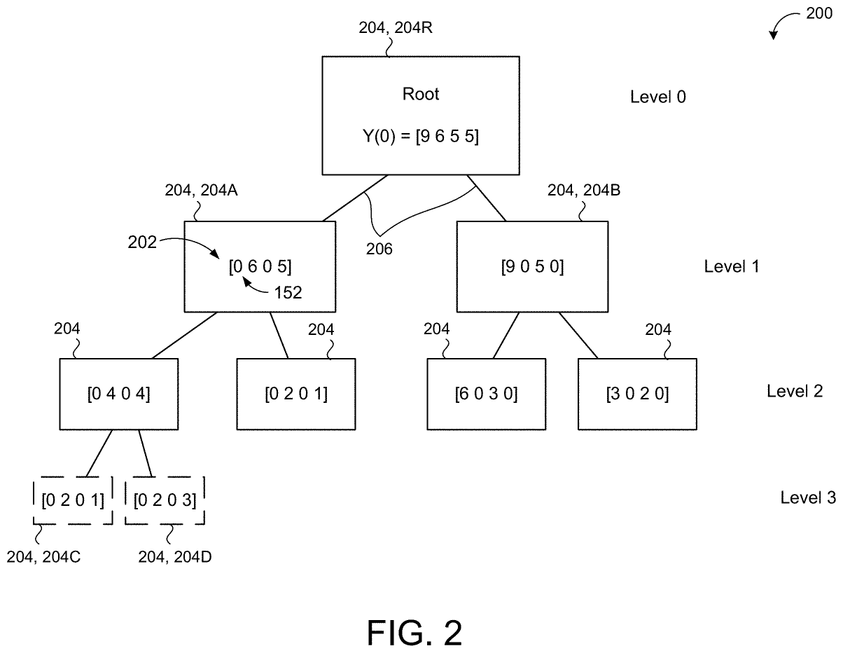

FIG. 2 illustrates an example schematic view of a hierarchical time series 200. The hierarchical time series 200 is a set of time series 202, and each time series 202 of the set of time series 202 is represented as a node 204 (leaf) of a tree diagram, where the edges 206 (i.e., links or branches) represent parent/child relationships between the nodes 204. Each time series 202 of the set of time series 202 can include one or more time series data values 152. In some implementations, the hierarchical time series 200 is coherent, meaning that each root/node relationship satisfies sum constraints over the hierarchy. For example, the time series 202 represented by a first node 204, 204A and the time series 202 represented by a second node 204, 204B, when summed, equal the time series 202 of the parent node 204 (i.e., the root node 204R in this example). In these examples, the hierarchy is coherent throughout, such that if you traverse through the hierarchy each parent node 204 is equal to the sum of the corresponding child nodes 204.

The regression and time series forecaster 160, in some examples, is configured to predict new nodes, such as nodes 204, 204C-D, including expected or future data values 152, 152F. Alternatively, the time series forecaster 160 is configured to predict changes to a time series over time, such as changes to any of the nodes 204 of the hierarchical time series 200 in defined increments of time (i.e., determining expected time series data values 152E). When forecasting changes to multiple nodes 204, the prediction for each node 204 may be dependent (i.e., constrained) on the predictions for each other node 204 such that the hierarchical time series 200 remains coherent.

The example hierarchical time series 200 is for illustrative purposes and is not intended to be limiting. A hierarchical time series 200 can include any number of nodes 204 as necessary to convey the corresponding data. Further, a root node 204 can have any number of corresponding child nodes 204 connected via edges 206.

In some implementations, the regression and time series forecaster 160 represents the hierarchical time series 200 as a matrix, where each node 204 of the hierarchical time series 200 corresponds to a vector of the matrix. In other implementations, the regression and time series forecaster 160 represents a hierarchical time series 200 as a pair of matrices. For example, a set of time series is denoted as a matrix Y=[y₁, . . . yₙ]^{T}, where y⁽ⁿ⁾ is then column of the matrix Y denoting all time steps of the nth time series, and yₜ⁽ⁿ⁾ is the t-th value of the n-th time series. The matrix Y can have a corresponding matrix of features X, where the t-th row denotes a D-dimensional feature vector at the t time step. In some implementations, the regression and time series forecaster 160, using model 412, uses matrices X and Y to forecast future time series values, where the predicted values may be conditioned on past time series values (Y) and past feature values (X) over a past H time steps.

As described above, a hierarchical time series 200 may be coherent. That is, the hierarchy satisfies a sum constraint. However, as a result of coherence, data is aggregated throughout the hierarchy which can cause widely varying scales between different levels of the hierarchy. Varying scales can make the data inefficient for a machine learning model. To combat this, the time series data values may be downscaled based on a level of hierarchy associated with the respective time series data value. For example, the time series 202 at each node 204 is downscaled by the number of nodes 204 (i.e., leaves) in the sub-tree rooted at the node 204, so that now they satisfy mean constraints rather than sum constraints. Downscaling can be performed prior to training or forecasting, and prepares the data to be used by the model 412. To maintain coherence in forecasted time series data values 152, the model 412 may include a mean aggregation constraint as an alternative to sum constraints (i.e., coherent constraints). An example mean aggregation constraint is illustrated in the following equation:

$${y}^{( p )} = \frac{1}{\vert L ( p ) \vert} {\sum }_{n ∈ L ( p )} {y}^{( n )} \qquad ( 1 )$$

Where L(p) denotes the set of leaf nodes of the sub-tree rooted at p. Further, the time series in a data set may be a linear combination of a small set of bases time series as represented by:

Y=Bθ+w (2)

Where B denotes the set of basis vectors, θ denotes the set of weight vectors used in the linear combination for each time series, and w denotes the noise matrix. Here, each row of B can be thought of as an evolving global state from which all the individual time series are derived.

The aim of the above is to obtain an implicit representation of a global basis that can be maintained as the weights of a deep network architecture like a set of sequence to sequence models when initialized in a data dependent manner. Given the above, the global basis can be modeled as a function of any given time-series as follows:

ŷₜ⁽ⁿ⁾=B̅(X_{H},y_{H}⁽ⁿ⁾;Ø)θₙ=B̅ₜ⁽ⁿ⁾ (3)

Here, θₙ is a learnable embedding for time series n. H represents an H-step history of the vector and the \hat{ } notation denotes predicted/estimated values, such as expected data values 152E. Further, in the above equation, B̅ may be a model that implicitly recovers the global basis given the history of any single time series from the data set. Here, the function B̅ can be modelled using any differentiable learning model, such as recurrent neural networks or temporal convolution networks.

Additionally or alternatively, the above equation is written with respect to a time-varying autoregressive (AR) model and the basis decomposition model. A combination of these two models satisfies the requirements of coherence in forecasting hierarchical time series. The model may be written as:

ŷₜ⁽ⁿ⁾=ƒ(y_{H}⁽ⁿ⁾,X_{H},Xₜ,Z_{H},θₙ)= [symbol] y_{H}⁽ⁿ⁾,a(X_{H},Xₜ,Z_{H}) [symbol] + [symbol] θₙ,b(X_{H},Xₜ,Z_{H}) [symbol] (4)

Here, [symbol] y_{H}⁽ⁿ⁾,a(X_{H},Xₜ,Z_{H}) [symbol] represents the time varying autoregressive model and [symbol] θₙ, b(X_{H},Xₜ,Z_{H}) [symbol] represents the basis decomposition model. In (4), Z_{H} is a latent state vector that contains some summary temporal information about the whole dataset, and θₙ is the embedding/weight vector for time series n in the basis decomposition model. The variable Z_{H} may be a relatively low-dimensional temporally evolving variable that represents some information about the global state of the dataset at a particular time. For example, Z is defined as Z=[Yⁿ¹ . . . Y^{nR}]. Typically, the past values of Z_{H} are fed as input to the model, as future values are not available during forecasting. Also, the final basis time-series may be a non-linear function of Z_{H}.

Referring back to equation (3), in some implementations, a basis regularization is implemented to keep the output of B̅ close for all of the time series in the data set. The basis regularization can be implemented as follows:

B_{reg}(B̅ₜ)=Σₙ₌₁^{N}∥B̅ₜ⁽ⁿ⁾−Bₜ^{(sh[n])}∥₂² (5)

In other words, basis regularization is based on a set of basis vectors associated with the set of hierarchical time series and represents a data-dependent global basis of the set of hierarchical time series.

As discussed above, for any coherent dataset, it holds that the time series values of any node p is equal to the mean of the time series values of the leaf nodes of the sub-tree rooted at P. Applying these constraints to equation (1) arrives at:

$${\hat{y}}_{t}^{( p )} = \frac{1}{\vert L ( p ) \vert} {\sum }_{n ∈ L ( p )} {\hat{y}}_{t}^{( n )} , or , {B}_{t} ( {θ}_{p} - \frac{1}{\vert L ( p ) \vert} {\sum }_{n ∈ L ( p )} {y}^{( n )} ) = 0 \qquad ( 6 )$$

The above vector equality must hold for any real Bₜ which implies that, for any node p, it also must hold that the embedding mean property is:

$${θ}_{p} = \frac{1}{\vert L ( p ) \vert} {\sum }_{n ∈ L ( p )} {θ}_{n} \qquad ( 7 )$$

Accordingly, the mean property for embeddings is a sufficient condition for the forecasts to be coherent. In view of the above, the following embedding regularization may directly encourage the mean aggregation property during training:

E_{reg}(θ)=Σₚ₌₁^{N}Σ_{n∈L(p)}∥θₚ−θₙ∥₂² (8)

The purpose of this regularizer is twofold. First, when the leaf embeddings are kept fixed, the regularizer is minimized when the embeddings satisfy the mean property (7), thus encouraging coherency in the predictions. Secondly, it also encodes the inductive bias present in the data corresponding to the hierarchical additive constraints. Here, the embedding regularization is based on a set of weight vectors (i.e., θ) associated with the hierarchical time series. Further, the embedding regularization provides a coherence constraint for the model during training and implementations.

Based on the above, a loss function can be defined as:

l(Ø,θ)=Σₜ(Σₙ|yₜ⁽ⁿ⁾−ŷₜ⁽ⁿ⁾|+λ_{B}B_{reg}(B̅ₜ))+λ_{E}E_{reg}(θ) (9)

Here, Σₙ|yₜ⁽ⁿ⁾−ŷₜ⁽ⁿ⁾| represents a base loss, λ_{B}B_{reg}(B̅ₜ) represents a basis regularization, and λ_{E}E_{reg}(θ) represents an embedding regularization. The loss function aims at minimizing a mean absolute error, the basis regularization, and the embedding regularization. In some implementations, the loss represented in equation (9) is minimized efficiently by mini-batch stochastic gradient descent.

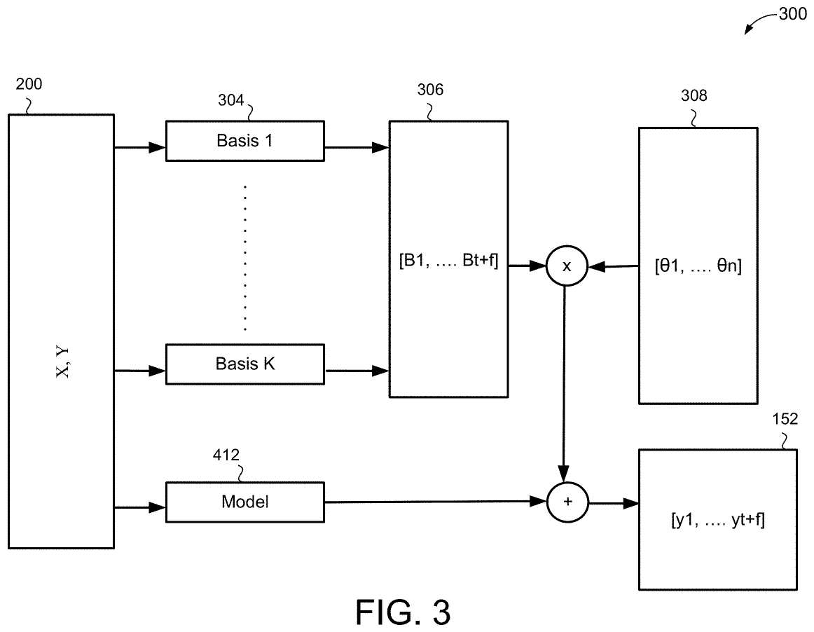

Referring now to FIG. 3, an example model architecture 300 forecasts time series data values 152. Here, given a hierarchical time series 200 represented as a pair of matrices, the regression and time series forecaster 160 uses a global basis 304 to determine a basis regularization 306 of the hierarchical time series 200. Further, the regression and time series forecaster 160 may determine an embedding regularization 308 based on the hierarchical time series 200. The regression and time series forecaster 160 may use the embedding regularization 308 and basis regularization 306 individually or in combination to train the model(s) 412. The trained model 412 may forecast at least one future time series data value 152 for a time series 202 in the set of hierarchical time series 200.

Referring now to FIG. 4, a training process 400 illustrates training an exemplary model 412 using the model trainer 410. Though a single model 412 is illustrated, the process 400 may generate and/or train multiple models 412 of different types or with different parameters. For example, the model 412 is a differentiable learning model and includes any of a deep neural network, a recurrent neural network, a temporal convolutional network, a long short term memory network, etc. Further, the training process 400 may include using mini-batch stochastic gradient descent techniques for training the model 412.

In some implementations, the process 400 employs a two-step training technique that includes pre-training and training. Pre-training is a technique used for initializing a model 412 which can then be further fine-tuned based on additional training data 415. For the model 412, pre-training may include initiating the model 412 with pre-training data 405 including a one or more time series, such as historical data values 152, 152H. For the model 412, pre-training may further include adjusting one or more parameters of the model 412 for a desired initial configuration of the model 412.

The process 400, in some examples, includes fine-tuning parameters of the pre-trained model 412. In these examples, the process 400 includes feeding a training samples 415 to the model 412. The training samples 415 can include any data that can be used to train a model 412 to forecast time series data values 152E. For example, the training samples 415 can include multiple time series, a regression dataset, etc. In some implementations, each training sample of the training samples 415 includes a response variable 416. For time series, response variables 416 are usually positive integers and are often sparse and occur at short intervals with a high probability of zeroes at each time-point. For example, a response variable 416 is a confidence interval. Further, the response variables 416 of the training samples 415 may include one or more distribution families. Further still, at least one distribution family includes a mixture distribution including multiple components, where each component may be representative of a different distribution family. For example, a component can represent a zero distribution, a negative binomial distribution, a normal distribution with fixed variance, etc. Each component may also include a mixture weight and a distribution.

Further, the training samples 415 may or may not be labeled with a label 430 indicating a target output associated with the training sample 415. In some examples, the model trainer 410 uses Maximum Likelihood Estimation (MLE) techniques to solve for a parameter in the distribution family of the response variables 416 of the training samples 415 that best explains the empirical data (i.e., determine a loss metric). The parameter may be used by the loss function 440 to determine a loss 450. Using maximum likelihood estimation techniques to determine a loss metric has advantages over having predefined labels 430. For example, using MLE to determine a loss metric at training time does not require a predefined loss and allows for an appropriate loss metric to be determined at inference time.

Upon receiving the training samples 415, the model 412 may generate an output 425 (e.g., a response variable, a forecasted time series). In some implementations, the output 425 is used by a loss function 440 to generate a loss 450. That is, the loss function 440 compares the output 425 and the label 430 to generate the loss 450, where the loss 450 indicates a discrepancy between the label 430 (i.e., the target output) and the output 425. The loss functions 440 may implement any suitable technique to determine a loss such as regression loss, mean squared error, mean squared logarithmic error, mean absolute error, binary classification, binary cross entropy, hinge loss, multi-class loss, etc. In some implementations, the loss function 440 uses the basis regularization and the embedding regularization to determine a loss 450, as discussed above. The loss 450 may then be fed directly to the model 412. Here, the model 412 processes the loss 450 and adjusts one or more parameters of the model 412 to account for the loss 450. In some implementations, the model 412 is continually trained (or retrained) as additional training samples 415 are received.

Once the model 412 is trained, the model 412 may obtain a test sample, which may or may not be a training sample 415. The model 412 may then predict a response variable 416 for the test sample. In some implementations, the model 412 implements Maximum Likelihood Estimation to predict the response variable 416.

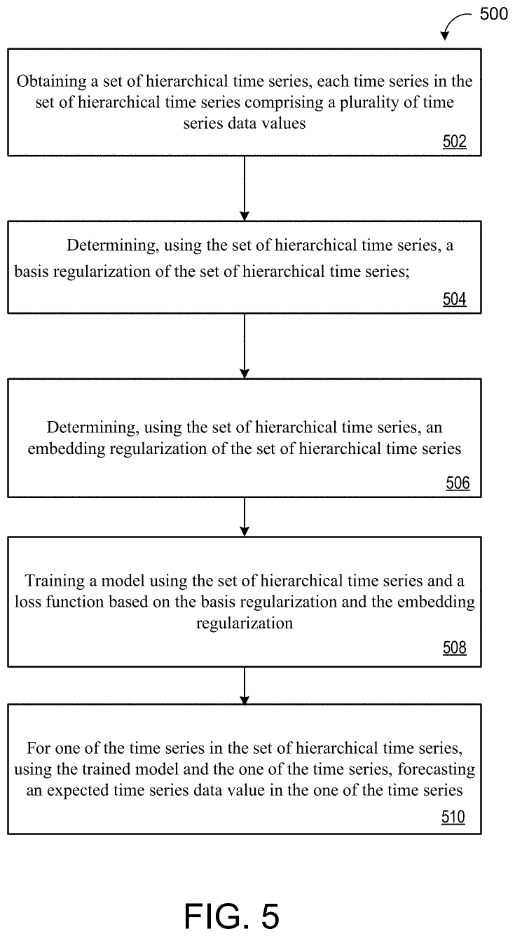

FIG. 5 is a flow chart of an exemplary arrangement of operations for a method 500 for forecasting a time series using a model 412. The method 500 may be performed, for example, by various elements of the time series forecasting system 100 of FIG. 1. At operation 502, the method 500 includes obtaining a set of hierarchical time series 202, each time series 202 in the set of hierarchical time series 202 including a plurality of time series data values 152. At operation 504, the method 500 includes determining, using the set of hierarchical time series 202, a basis regularization 306 of the set of hierarchical time series 202. At operation 506, the method 500 includes determining, using the set of hierarchical time series 202, an embedding regularization 308 of the set of hierarchical time series 202. At operation 508, the method 500 includes training a model 412 using the set of hierarchical time series 200 and a loss function 440 based on the basis regularization 306 and the embedding regularization 308. At operation 510, the method 500 includes forecasting, using the trained model 412 and one of the time series in the set of hierarchical time series, an expected time series data value 152E in the one of the time series 202.

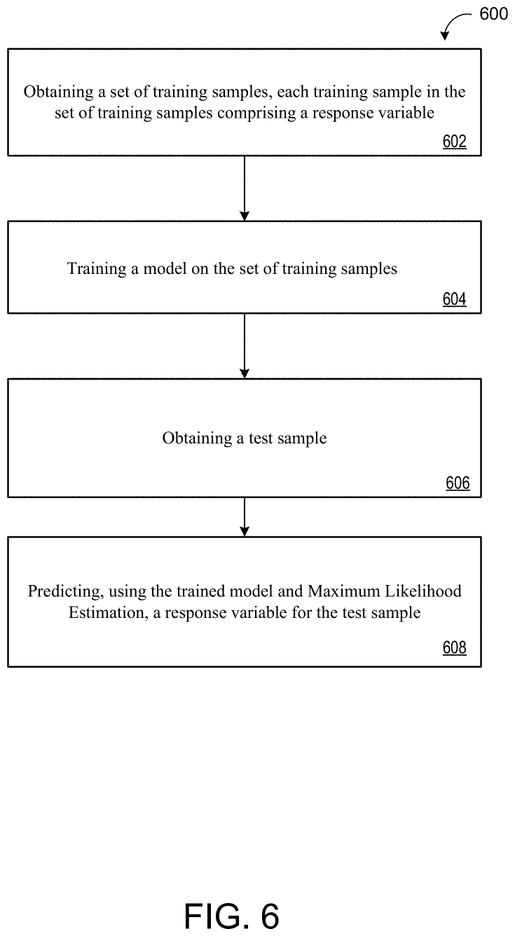

FIG. 6 is a flow chart of an exemplary arrangement of operations of a method 600 for training a model 412 for forecasting a time series 202. The method 600 may be performed by various elements of the time series forecasting system 100 of FIG. 1. At operation 602, the method 600 includes obtaining a set of training samples 415, each training sample 415 in the set of training samples 415 including a response variable 416. At operation 604, the method 600 includes training a model 412 on the set of training samples 415. At operation 606, the method 600 includes obtaining a test sample 415. At operation 608, the method 600 includes predicting, using the trained model 412 and a Maximum Likelihood Estimation, the response variable for the test sample 415.

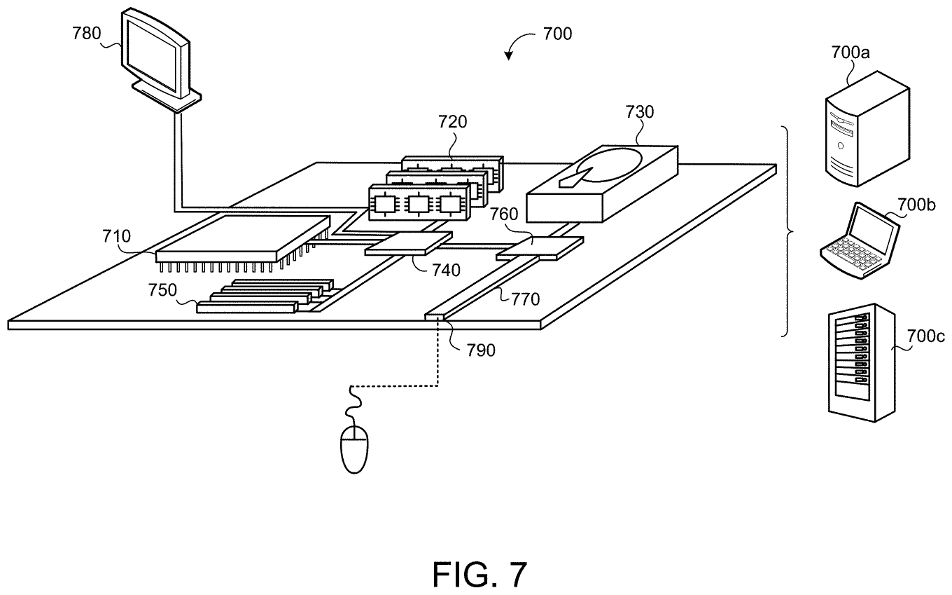

FIG. 7 is schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710, memory 720, a storage device 730, a high-speed interface/controller 740 connecting to the memory 720 and high-speed expansion ports 750, and a low speed interface/controller 760 connecting to a low speed bus 770 and a storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed by data processing hardware causes the data processing hardware to perform operations comprising:
obtaining a set of hierarchical time series, each time series in the set of hierarchical time series comprising a plurality of time series data values;
determining, using the set of hierarchical time series, a basis regularization of the set of hierarchical time series;
determining, using the set of hierarchical time series, an embedding regularization of the set of hierarchical time series;
training a model using the set of hierarchical time series and a loss function based on the basis regularization and the embedding regularization; and
forecasting, using the trained model and one of the time series in the set of hierarchical time series, an expected time series data value in the one of the time series.

2. The method of claim 1, wherein the loss function comprises minimizing a sum of a mean absolute error, the basis regularization, and the embedding regularization.

3. The method of claim 1, wherein training the model comprises using mini-batch stochastic gradient descent.

4. The method of claim 1, wherein the operations further comprise, prior to training the model, for each respective time series data value, downscaling the respective time series data value based on a level of hierarchy associated with the respective time series data value.

5. The method of claim 1, wherein the set of hierarchical time series comprises a pre-defined hierarchy of a plurality of nodes, each node associated with one of the time series data values.

6. The method of claim 1, wherein the basis regularization is based on a set of basis vectors associated with the set of hierarchical time series.

7. The method of claim 1, wherein the embedding regularization is based on a set of weight vectors associated with the set of hierarchical time series.

8. The method of claim 1, wherein:
the basis regularization represents a data-dependent global basis of the set of hierarchical time series; and
the embedding regularization provides a coherence constraint on the trained model.

9. The method of claim 1, wherein the model comprises a differentiable learning model.

10. The method of claim 9, wherein the differentiable learning model comprises a recurrent neural network, a temporal convolutional network, or a long short term memory network.

11. A system comprising:
data processing hardware; and
memory hardware in communication with the data processing hardware, the memory hardware storing instructions that when executed on the data processing hardware cause the data processing hardware to perform operations comprising:
obtaining a set of hierarchical time series, each time series in the set of hierarchical time series comprising a plurality of time series data values;
determining, using the set of hierarchical time series, a basis regularization of the set of hierarchical time series;
determining, using the set of hierarchical time series, an embedding regularization of the set of hierarchical time series;
training a model using the set of hierarchical time series and a loss function based on the basis regularization and the embedding regularization; and
forecasting, using the trained model and one of the time series in the set of hierarchical time series, an expected time series data value in the one of the time series.

12. The system of claim 11, wherein the loss function comprises minimizing a sum of a mean absolute error, the basis regularization, and the embedding regularization.

13. The system of claim 11, wherein training the model comprises using mini-batch stochastic gradient descent.

14. The system of claim 11, wherein the operations further comprise, prior to training the model, for each respective time series data value, downscaling the respective time series data value based on a level of hierarchy associated with the respective time series data value.

15. The system of claim 11, wherein the set of hierarchical time series comprises a pre-defined hierarchy of a plurality of nodes, each node associated with one of the time series data values.

16. The system of claim 11, wherein the basis regularization is based on a set of basis vectors associated with the set of hierarchical time series.

17. The system of claim 11, wherein the embedding regularization is based on a set of weight vectors associated with the set of hierarchical time series.

18. The system of claim 11, wherein:
the basis regularization represents a data-dependent global basis of the set of hierarchical time series; and
the embedding regularization provides a coherence constraint on the trained model.

19. The system of claim 11, wherein the model comprises a differentiable learning model.

20. The system of claim 19, wherein the differentiable learning model comprises a recurrent neural network, a temporal convolutional network, or a long short term memory network.
